(19) United States
(12) Patent Application Publication
(10) Pub. No.: US 2021/0142572 A1
(43) Pub. Date: May 13, 2021

(54) 3D AR CONTENT CREATION DEVICE, 3D AR CONTENT PLAYBACK DEVICE, AND 3D AR CONTENT CREATION SYSTEM

(71) Applicant: MAXELL, LTD., Kyoto (JP)

(72) Inventors: Hiroshi SHIMIZU, Kyoto (JP); Masuo OKU, Kyoto (JP); Yasunobu HASHIMOTO, Kyoto (JP); Osamu KAWAMAE, Kyoto (JP); Mitsunobu WATANABE, Kyoto (JP)

(21) Appl. No.: 17/057,065

(22) PCT Filed: May 24, 2018
(86) PCT No.: PCT/JP2018/020068

§ 371 Date: Nov. 19, 2020

(51) Int. Cl. G06T 19/00; G06T 7/50; H04N 13/361

(52) U.S. Cl. CPC G06T 19/006; G06T 7/50; H04N 5/23238; G06T 2207/10012; H04N 13/361

(57) ABSTRACT

There are provided a 3D AR content creation device, a 3D AR content playback device, and a 3D AR content creation system capable of performing 3D display in consideration of the depth relationship between a background image and a 3D AR object. For the purpose, the 3D AR content creation device includes a camera, a position information sensor that detects position information of the camera, and a controller. The controller measures depths of feature points of at least a part of a background image captured by the camera, gives position coordinates of a space corresponding to the background image to an AR object having the feature points of the background image and a 3D image from the position information of the camera and the measured depths of the feature points, and evaluates depths of the feature points of the background image and the AR object to obtain a composite image.

### TECHNICAL FIELD

The present invention relates to a 3-dimensional (3D) argument reality (AR: virtual reality) content creation device for creating the 3D AR content including a 3D image and a 3D AR object, a 3D AR content playback device for reproducing and displaying the 3D AR content, and a 3D AR content creation system including these.

### BACKGROUND ART

Images captured from the player's perspective are captured with a camera to share the experiences of activities, such as sports. At this time, the player often uses a so-called “action camera” in which a camera is fixedly mounted on a helmet or a hair band. A viewer can view the images captured by the action camera or the like in real time on a display device, such as a “smartphone”, through a network, or can view the images captured by the action camera or the like in a time-shifted manner after temporarily storing the images in a storage device inside the camera.

In addition, AR is used. In the AR, an image called an AR trigger is captured by a camera, and information such as computer graphics (CG) linked by the AR trigger is combined with the camera image and displayed.

In addition, in JP 2016-53788 A (Patent Document 1) proposes a method of projecting and displaying a 3D AR object on a camera image to provide AR content. In addition, a method of storing a camera image and a 3D AR object is also disclosed.

### CITATION LIST

### Patent Document

Patent Document 1: JP 2016-53788 A

### SUMMARY OF THE INVENTION

### Problems to be Solved by the Invention

Patent Document 1 discloses that a 3D AR object is converted into 2D and displayed so as to be overlaid on a camera image, but the background image is a 2D image. Therefore, since it is not possible to perform 3D display considering the depth relationship between the background image and the 3D AR object, there is a problem that this is not sufficient to provide the 3D AR content to the viewer. In addition, when the 3D AR object is arranged in all directions of 360°, it is necessary to provide 3D AR content in which the 3D AR object is combined with a 360° camera image.

The present invention has been made in view of the aforementioned problems, and an object thereof is to provide a device for creating 3D AR content by combining a 3D AR object with a camera image, a 3D AR content playback device, and 3D AR content creation system.

### Solutions to Problems

In view of the background art and problems described above, according to an example of the present invention, a 3D AR content creation device includes: a camera; a position information sensor that detects position information of the camera; and a controller. The controller measures depths of feature points of at least a part of a background image captured by the camera, gives position coordinates of a space corresponding to the background image to an AR object having the feature points of the background image and a 3D image from the position information of the camera and the measured depths of the feature points, and evaluates depths of the feature points of the background image and the AR object to obtain a composite image.

### Effects of the Invention

According to the present invention, it is possible to provide a 3D AR content creation device, a 3D AR content playback device, and a 3D AR content creation system capable of performing 3D display in consideration of the depth relationship between a background image and a 3D AR object. In addition, it is possible to provide a system capable of creating and storing the 3D AR content in a 360° direction even when 3D AR objects are arranged in all directions of 360°.

### BRIEF DESCRIPTION OF THE DRAWINGS

FIG. 1 is a schematic diagram of the appearance of a 3D AR content creation device according to a first embodiment.

FIG. 2 is a block diagram of the configuration of the 3D AR content creation device according to the first embodiment.

FIG. 3 is a first display example of 360° 3D AR content in the first embodiment.

FIG. 4 is a second display example of 3D AR content in the first embodiment.

FIG. 5 is a third display example of 360° 3D AR content in the first embodiment.

FIG. 6 is a diagram describing a menu object in the first embodiment.

FIG. 7 is a diagram describing space shape data of a 3D image in the first embodiment.

FIG. 8 is a diagram describing the parameter setting of a 3D AR object in the first embodiment.

FIG. 9 is a diagram describing mask processing on the 3D AR content in the first embodiment.

FIG. 10A is an example of data forming the 3D AR content in the first embodiment.

FIG. 10B is an example of data forming the 3D AR content in the first embodiment.

FIG. 10C is an example of data forming the 3D AR content in the first embodiment.

FIG. 11 is a process flow diagram of the 3D AR content creation device according to the first embodiment.

FIG. 12 is a schematic diagram of the appearance of a 3D AR content creation device according to a second embodiment.

FIG. 13 is a block diagram of the configuration of the 3D AR content creation device according to the second embodiment.

FIG. 14 is a display example of the 3D AR content creation device according to the second embodiment.

FIG. 15 is a configuration diagram of a 3D AR content creation system according to a third embodiment.

FIG. 16 is a configuration diagram of a 3D AR content creation system according to a fourth embodiment.

FIG. 17 is a block diagram of the configuration of a 3D AR content playback device according to a fifth embodiment.

FIG. 18 is a process flow diagram of the 3D AR content playback device according to the fifth embodiment.

FIG. 19 is a diagram describing a display setting object in the fifth embodiment.

FIG. 20 is a first display example of the 3D AR content playback device according to the fifth embodiment.

FIG. 21 is a second display example of 360° of the 3D AR content playback device according to the fifth embodiment, and is a diagram describing an operation object.

FIG. 22 is a process flow diagram of a combination processing unit in the fifth embodiment.

### MODE FOR CARRYING OUT THE INVENTION

Hereinafter, embodiments of the present invention will be described with reference to the diagrams.

### First Embodiment

FIG. 1 is a schematic diagram of the appearance of a 3D AR content creation device according to the present embodiment. In FIG. 1, 1 is a 3D AR content creation device, 10a and 10b are wide-angle cameras, 11a and 11b are 3D cameras, 12 is a display, 13 is a polarization optical lens, 14a and 14b are speakers, 15 is a controller, 16a and 16b are mounting portions, and 17 is a sensor.

The creator of the 3D AR content mounts the 3D AR content creation device 1 (hereinafter, also referred to as a device 1) on his/her head using the mounting portions 16a and 16b. The mounting portion 16a is for fixing in the upper and lower directions of the head, and the mounting portion 16b is for fixing in the front and rear directions of the head.

The wide-angle camera 10a is attached so as to image a side in front of the head (front of the line of sight of the creator). For example, the wide-angle camera 10a is a camera with an imaging angle of view of 180° in the vertical and horizontal directions, and images a front hemisphere range. The wide-angle camera 10a is attached so as to image a side behind the head (a side behind the line of sight of the creator), and similarly images a rear hemisphere range in which the imaging angle of view of the camera is 180° in the vertical and horizontal directions. The wide-angle cameras 10a and 10b are combined to capture an image of approximately 360° around the head.

In the 3D cameras 11a and 11b, 11a is attached to the left side of the device 1 to capture an image of the creator's left front line of sight, and 11a is attached to the right side of the device 1 to capture an image of the creator's right front line of sight. An image (hereinafter, may be referred to as a 3D image) to be captured by a 3D camera, which is a stereoscopic image, is captured by two images having left and right parallax. In addition, the 3D camera may be a camera that measures a distance by emitting infrared light or the like and capturing reflected light. At this time, the 3D camera may be installed adjacent to the wide-angle camera to measure the distance of a region including the center of the image captured by the wide-angle camera. However, 3D (stereo) images cannot be obtained at this time.

The controller 15 acquires captured images of the wide-angle cameras 10a and 10b and the 3D cameras 11a and 11b, and stores the captured images in an internal storage device and creates an image projected on the display 12 or sounds played on the speakers 14a and 14b. The image projected on the display 12 is an image obtained by combining the images (hereinafter, may be referred to as wide-angle images) of the wide-angle cameras 10a and 10b and the 3D images of the 3D cameras 11a and 11b with a 3D AR object. In addition, a driving signal of the polarization optical lens 13 is generated, and the transmission of only the left side and the transmission of only the right side are repeated in synchronization with a composite 3D image projected on the display 12, so that the creator checks the composite 3D image in such a manner that the image of the left line of sight is viewed with the left eye of the creator and the image of the right line of sight is viewed with the right eye of the creator.

In addition, the controller 15 calculates depth (distance) information for each portion of the 3D image captured by the 3D cameras 11a and 11b by using the left and right parallax. By combining this depth information with edge information of the image and the like, surface data of a segmented space shape, which will be described later with reference to FIG. 7, is obtained. The surface data of the space shape and the 3D AR object are managed in the position coordinate space corresponding to position information by the sensor 17, such as a GPS, of the device 1 and the image captured by the wide-angle camera.

FIG. 2 is a block diagram of the configuration of the 3D AR content creation device according to the present embodiment. In FIG. 2, the same components are denoted by the same reference numerals. In addition, 17a is a position information sensor, 17b is a geomagnetic sensor, and 17c is a gyro sensor, which correspond to the sensor 17 in FIG. 1 and are mounted on the mounting portions 16a and 16b and the like. 18 is a user operation input unit, and the device 1 is operated by a touch panel or the like. In addition, 151a is a space shape surface processing unit, 151b is a depth information processing unit, 151c is a brightness information processing unit, 151d is a color information processing unit, 152 is a combination processing unit, 153 is a mask processing unit, 154a is a CPU, 154b is a RAM, 154c is a ROM, 154d is a communication unit, 155 is a spatial position coordinate processing unit, 156a is a wide-angle image holding unit, 156b is a 3D image holding unit, 156c is a space shape surface data holding unit, 156d is a 3D AR object holding unit, 156e is a 2D image holding unit, 156f is a 2D AR object holding unit, 156g is a line-of-sight movement data holding unit, 157 is a 2D conversion processing unit, 158 is a 2D composite image and thumbnail data holding unit, and 159 is a user operation data holding unit. These configure the controller 15.

The image of the wide-angle camera 10a is acquired by the controller 15 and stored in the wide-angle image holding unit 156a. In addition, the image of the 3D camera is input to the brightness information processing unit 151c and the color information processing unit 151d as well as being stored in the 3D image holding unit 156b.

The brightness information processing unit 151c and the color information processing unit 151d extract change points (edges and the like) of brightness information and color information, respectively. In the depth information processing unit 151b, the left and right parallax of these changes is measured to obtain depth data. The depth data is transmitted to the spatial position coordinate processing unit 155 and the like. The space shape surface processing unit 151a extracts feature points based on the change points and the depth data and generates space shape surface data, and stores the space shape surface data to the space shape surface data holding unit 156c. As will be described later in FIG. 7, the space shape surface data is polygon data having feature points as its vertices, and is surface data that abstracts a 3D image. Depth data is given to each vertex, and the 3D shape of the 3D image can be grasped by the space shape surface data.

The position information sensor 17a is, for example, a GPS sensor or an altitude sensor, and measures the current position of the device 1. The geomagnetic sensor 17b measures the direction of the device 1. The gyro sensor 17c grasps the speed of the device 1 or the movement such as displacement of the device 1 from the measured acceleration of the device 1. The movement of the head is detected by the direction of the geomagnetic sensor 17b and the movement of the gyro sensor 17c, so that the movement of the line of sight of the user of the device 1 is detected. The movement data of the line of sight is stored in the line-of-sight movement data holding unit 156g.

The spatial position coordinate processing unit 155 manages the position and direction of the device 1, depth data of each vertex of the above-described space shape surface data (hereinafter, may be referred to as surface data), the position of the 3D AR object, and the like. The pieces of data are associated with time information and the position coordinate space captured by a wide-angle camera. Specifically, using the current position of P0=(x0, y0, z0) and the direction of the line of sight of (horizontal, vertical) =(θ0, θ0) at time T0 (initial state) as an initial value, the position of a difference from the initial value is calculated to obtain the spatial position coordinates. That is, a coordinate system using the position and direction of the device 1 on the space as a reference is defined, and the spatial position coordinate system moves according to a change in the movement or orientation of the device 1.

In the initial state, when the vertex of surface data in a 3D image is P1=(r1, θ1, θ1), P1 is given to the vertex as the spatial position coordinates. Here, (r1, θ1, θ1) is a polar coordinate system, where r1 is a distance, θ1 is a horizontal angle, and θ1 is a vertical angle.

When the device 1 moves, assuming that the amount of movement is P2=(r2, θ2, θ2), the spatial position coordinates are recalculated based on the P2. The origin of the spatial position coordinate system of the 3D image before movement is −P2 in the spatial position coordinate system after movement, and the spatial position coordinates of the vertex to which the previous P1 is given are P3=P1−−P2 (where, this is a composite operation in the polar coordinate system). In addition, when the vertex of surface data in a new 3D image is P4=(r4, θ4, θ4), P4 is given to the vertex.

Similarly, when the device 1 further moves, the spatial position coordinates of the vertices of the previous 3D image or surface data are recalculated based on the current position of the device 1, and spatial position coordinates are given to the vertices of the new 3D image or surface data. As a result, even when there is a movement of the device 1, a series of 3D images, surface data in 3D images, and 3D objects described below can be arranged in the position coordinate space captured by the wide-angle cameras 10a and 10b after movement.

In addition, when the amount of movement of the device 1 is too large from the initial value, the spatial position coordinates may be initialized to resume the calculation of the spatial position coordinates.

In addition, spatial position coordinates are also given to the 3D AR object, and the 3D AR object is arranged in the position coordinate space captured by the wide-angle cameras 10a and 10b. The 3D AR object to which the spatial position coordinates are given is stored in the 3D AR object holding unit.

The arrangement of the 3D AR object in the position coordinate space is performed by the content creator through the user operation input unit 18. Through the user operation input unit 18, operations such as rotation, size change, and color correction of the 3D AR object can also be performed, and operation data is stored in the user operation data holding unit 159 together with the operation time.

The 3D image of the 3D image holding unit 156b or the 3D AR object of the 3D AR object holding unit 156d is read, and is then converted into a 2D image by the 2D conversion processing unit 157 and stored in the 2D image holding unit 156e and the 2D AR object holding unit 156f. The 2D image or the 2D AR object is intended to enable the display of 3D AR content even when the display is performed on a 2D display device in the 3D AR content playback device. By the spatial information coordinates given to the 2D image or the 2D AR object, it is possible to view the 3D AR content with a sense of depth, such as maintaining the depth relationship between the 2D image or the 2D AR object or switching the display image by moving the line of sight.

The combination processing unit 152 combines the wide-angle image (image captured by the wide-angle camera) or the 3D image (image captured by the 3D cameras) and the 3D AR object, and displays the 3D content on the display 12. Referring to the surface data of the 3D image, the combination processing unit 152 makes an image located behind covered by an image located ahead based on the relationship between the 3D image and the 3D object. In addition, the display 12 may have a planar shape that is, for example, a concave shape to improve the visibility of the 3D AR content.

In addition, the mask processing unit 153 performs mask processing by designating surface data, which includes, for example, personal information in a 3D image, of a region which is desired to avoid being displayed for a viewer who is not limited by the 3D AR content playback device. In the mask processing, replacement with other images may be performed as well as simply masking.

The communication unit 154d plays a role of connecting the 3D AR content creation device 1 to the network. For example, the communication unit 154d is connected to the 3D AR content playback device 1 through the network, or transmits the 3D AR content in response to a request from the 3D AR content playback device.

In addition, the processing of each processing unit in FIG. 2 may be performed by software processing in which the CPU executes a program stored in the memory, or may be performed by hardware processing using a dedicated signal processing circuit. In addition, software processing and hardware processing may be performed in combination.

FIG. 3 is a first display example of 360° 3D AR content created by the 3D AR content creation device 1 according to the present embodiment, which is displayed on the display 12 and checked by the creator.

In FIG. 3, 2 is a wide-angle image, 3 is a 3D image, 4a, 4b, 4c, 4d, 4e, and 4f are 3D AR objects.

The wide-angle image 2 is obtained by processing images of two cameras of the wide-angle cameras 10a and 10b, and is processed into an image captured by a virtual wide-angle camera, which is assumed to be installed above the head of the creator, and displayed. The creator's line of sight faces the vertical upward of the wide-angle image 2. The upper half indicated by “2a arrow” of the wide-angle image 2 is an image captured by the wide-angle camera 10a and is an image ahead of the creator's line of sight, and the lower half indicated by “2b arrow” of the wide-angle image 2 is an image of the wide-angle camera 10b and is an image behind the creator's line of sight.

The 3D image 3 is overlaid on the wide-angle image 2. The 3D cameras 11a and 11b image a side in front of the creator, and subjects projected in the 3D image 3 are arranged in the upper portion of the wide-angle image 2 so as to be located at the front. The image 3 of the 3D camera is a 3D image. In the device 1 of FIG. 2, the creator can confirm this as a 3D image.

FIG. 3 is a content based on the assumption that the 3D AR object 4a of a bicycle (assuming that the creator is riding) guides a street corner while moving around the street corner. The wide-angle image 2 and the 3D image 3 are updated each time the creator moves around the street corner. Along with this, the 3D AR object 4a also moves. The 3D AR object 4b is similarly an object of a bicycle, and settings of accompanying the 3D AR object 4a are made. The 3D AR objects 4a and 4b of the bicycles are superimposed on the 3D image 3 as objects of the 3D image.

The 3D AR objects 4c and 4d are objects such as shops that the creator dropped in or introduced while moving around the street corner. For example, when the creator stops at a shop or the like, the creator arranges the object. In FIG. 3, the 3D AR objects 4c and 4d are arranged in the shape of a shop. However, when the 3D AR objects 4c and 4d are superimposed on the wide-angle image 2, the shapes of 4c and 4d may be deformed according to their spatial position coordinates and superimposed on the wide-angle image 2. For the once arranged object, when the creator moves thereafter, the spatial position coordinates are recalculated, so that the creator moves to the front and automatically displayed at a rear position (10b) of the wide-angle image 2 outside the 3D image.

The 3D AR objects 4e and 4f are objects of public objects that are open to the public, and the position information that are open to the public is converted into spatial position coordinates and combined with the wide-angle image 2 or the 3D image 3 as a 3D AR object. The spatial position coordinates of these objects are fixed to the street corner, and it is possible to perform arrangement in advance before the creator moves. In addition, once arranged, when the creator moves closer, the spatial position coordinates are recalculated and the display is updated so as to be closer.

FIG. 4 is a second display example of the 3D AR content created by the 3D AR content creation device 1 according to the present embodiment. In FIG. 4, the 3D image 3 of the 3D cameras 11a and 11b is projected on the entire surface of the display 12. In addition, the 3D AR objects 4a, 4b, 4e, and 4f described in FIG. 3 are combined and displayed. Even in this case, the wide-angle cameras 10a and 10b perform imaging and the position coordinate space of the wide-angle image 2 is maintained in the background, so that the display screens in FIGS. 3 and 4 can be arbitrarily switched.

In addition, when the above-described 3D image is not captured, the 3D image 3 may be a 2D image with depth data. The 2D image may be, for example, an image obtained by cutting a wide-angle image according to the line of sight of the creator.

FIG. 5 is a third display example of 360° 3D AR content created by the 3D AR content creation device 1 according to the present embodiment. In FIG. 5, the wide-angle image 2 is projected on the display 12, and the 3D AR objects 4a, 4b, 4e, and 4f are combined thereon and displayed. In FIG. 5, the wide-angle image 2 is the display 12, and the 3D AR objects 4a, 4b, 4e, and 4f are displayed on it. In FIG. 5, since the device 1 has the 3D display function, the 3D AR objects 4a, 4b, 4e, and 4f are combined with the wide-angle image 2 as a 3D image. In FIG. 5, since the device 1 has a 3D display function, the 3D AR objects 4a, 4b, 4e, and 4f are combined with the wide-angle image 2 as 3D images. At this time, depth information is given to a part of the wide-angle image 2 by using the surface data of the space shape, and combination is performed with the depth information as auxiliary data. In FIG. 5, the 3D AR objects 4a, 4b, 4e, and 4f are arranged in their original shapes. However, when these are superimposed on the wide-angle image 2, the shapes of 4a, 4b, 4e, and 4f may be deformed according to their spatial position coordinates and superimposed on the wide-angle image 2.

In addition, the 3D AR objects 4a, 4b, 4e, and 4f are held in the 2D AR object holding unit 156f as 2D AR objects by the 2D conversion processing unit 157. At the same time, a 2D composite image in which the 3D AR objects 4a, 4b, 4e, and 4f converted into 2D and the wide-angle image 2 are combined in the same manner is stored in the 2D composite image and thumbnail data holding unit. The 2D composite image is distributed to, for example, a 3D AR content playback device and used as a thumbnail image for selecting the 3D AR content, or the 2D composite image of the 3D AR content is also viewed in the 3D AR content playback device having only a 2D display function.

FIG. 6 is a diagram describing different types of 3D AR objects in the present embodiment. FIG. 6 shows a case where the line of sight of the creator moves and the 3D cameras 11a and 11b pan, and the 3D image moves from the display area of a display 12a to the display area of a display 12b. In FIG. 6, the display areas of the display 12a and 12b are shown to move. However, in practice, the display 12 is fixed and the displayed image moves.

In FIG. 6, two types of 3D AR objects are placed. One is 4a, and the other is 5a and 5b. 5a and 5b are one object, but are projected on the displays 12a and 12b, respectively. The 3D AR objects 5a and 5b are, for example, control objects for content control, and this type of object may be placed at a fixed position on the display 12 regardless of the movement of the image due to the panning of the 3D camera. Therefore, the spatial position coordinates are maintained so that the positions are the same in the display areas of the displays 12a and 12b. An object that is used when the user switches or controls the display, such as a control object for content control, is placed at a short distance that is easy to see so that the object is not hidden in the shadow of other real images as much as possible. However, since always placing an object at the center of the screen interferes with the field of view. Therefore, the object can be displayed at the same position as close to the edge of the display area as possible. On the other hand, the spatial position coordinates of the 3D AR object 4a of the bicycle described in FIGS. 3, 4, and 5 change in the opposite direction due to the movement of the pan, so that the position in the display area differs between the displays 12a and 12b.

FIG. 7 is a diagram describing surface data of the space shape of a 3D image in the present embodiment. As shown in FIG. 7, space shape surface data 6 is a polygon (triangles in the diagram) covering the entire area of the image 3 of the 3D camera, and depth data is given to the vertices. The spatial position coordinates of each vertex are calculated from the depth data and the spatial position coordinates of the 3D camera. Therefore, by comparing the spatial position coordinates of the depth of the surface data with the spatial position coordinates given to the 3D AR object, which image should be displayed in front when combining images can be determined.

FIG. 8 is a diagram describing the parameter setting of a 3D AR object in the present embodiment. FIG. 8 is an example of a menu display, which is set by the user through a touch panel operation or a remote control operation using the user operation input unit 18.

In addition, a parameter setting object 7 for setting the parameter of the 3D AR object may also be a kind of 3D AR object, and is set for each object.

In FIG. 8, parameters “transparency” and “display priority” that can be set are items that set the display relationship between the 3D AR object and the camera image. Transparency allows the background image to be displayed to some extent when the 3D AR object is on the front, and display priority allows the 3D AR object to be overlaid on the front side regardless of the depth relationship with the surface data. For example, this is the case of the control objects indicated by 5a and 5b in FIG. 6. “Position correction (horizontal)”, “position correction (vertical)”, “rotation correction (horizontal)”, “rotation correction (vertical)”, and “size” are items for changing the arrangement position, posture rotation control, and size of the 3D AR object.

In addition, “movement mode” and “display mode” are items for setting a method of moving and displaying a 3D AR object for the movement of the camera, that is, the creator's line of sight, and are associated with a method of recalculating the spatial position coordinates.

In general, 3D AR objects are arranged at the position of a wide-angle image at the current time and the position Px of the coordinate space having the line-of-sight direction as its origin. After the arrangement, when the position of the wide-angle image and the line-of-sight direction are moved by the movement amount Py, the coordinate space is updated, and the position in the new coordinate space of the 3D AR object arranged at Px in the entire coordinate space is updated to Px-Py. Each time the coordinate space is updated with such a fixed background image, for the 3D AR object whose position is to be recalculated, “Coordinates” are selected for both the movement mode and the display mode.

The 3D AR object for which “accompanying” is selected in the movement mode is a type in which the positional relationship with the content creation device, which will be described later with reference to FIG. 15, is obtained by communication, and the 3D AR object 4a in FIGS. 4 to 6 corresponds thereto.

5a and 5b in FIG. 6 correspond to 3D AR objects for which “screen interlocking” is selected in the display mode. The 3D AR object for which “screen interlocking” is selected in the display mode is a type in which the position with respect to the line of sight is fixed so that the 3D AR object is always displayed at a specific position on the display screen. In addition, “accompanying” and “screen interlocking” are exclusive and are prohibited from being selected at the same time.

FIG. 9 is a diagram describing mask processing on the 3D AR content in the present embodiment. In FIG. 9, a surface area 8a to be masked is selected from the surface data of the space shape by a user operation, such as a touch, and is executed in a mask setting object 8b.

FIGS. 10A, 10B, and 10C are diagrams describing data forming the 3D AR content in the present embodiment. As described in FIG. 2, data forming the 3D AR content (hereinafter, referred to as configuration data) is header data and some or all of line-of-sight movement data, object operation data, wide-angle image data, 3D image data, space shape surface data, 2D image data, 3D AR object data, 2D AR object data, and 2D composite image data.

The storage of the header data is not explicitly shown in the description of FIG. 2, but may be allocated to a part of the ROM 154c, for example. In addition, FIG. 2 illustrates an example in which each piece of data is placed in each storage unit, but the data may be stored in logically distinct areas in physically one storage medium.

In FIG. 10A, the contents of header data, line-of-sight movement data, object operation data, and wide-angle data are described.

Each piece of configuration data has an item “CONTENTS ID”, and the ID data of the “CONTENTS ID” is a number given according to a rule, such as universally unique identifier (UUID), and is a unique number for all contents. In addition, by the item “CONTENT TYPE”, it is possible to identify what kind of data each piece of configuration data is.

In addition to the header data, the content name is described in the item “CONTENTS TITLE”, the owner is described in the item “CONTENTS HOLDER”, and copyright control data is described in the item “COPYRIGHT POLICY”. In addition, the presence or absence of data accompanying the content of each piece of configuration data is indicated in the item “Accompanying Content”. The 3D AR content may include all pieces of configuration data, but may not include some configuration data.

The line-of-sight movement data is timeline data of the position data according to the detection time series of the line-of-sight movement. The line-of-sight movement may be data in frame units of the wide-angle image in the case of continuous movement, or may be performed at a time when the movement is stopped after the continuous movement in order to reduce data or processing. FIG. 10A describes the position data of the device at T1 and T2, assuming that there are two movements from the start time T0 of the content. Data P0 at T0 is position information of the GPS or the like, while data P1 and P2 at T1 and T2 are information indicating how much the position has moved from the position at the previous time as a reference. (r*, θ*, θ*) indicates a position change, and δ* indicates a change in the line-of-sight direction.

The object operation data is timeline data that describes the content of the object operation in a time series in which the operation has been performed. At TO0, Object1 is arranged (SET) at the position (r3, θ3, θ3) in the spatial position coordinate system. A rotation (ROT) operation is performed at TO1, an enlargement (ENL) operation is performed at TO2, and Object2 is arranged at TO3.

The wide-angle image data is video and audio (may be omitted) data, and the types of CONTAINER and CODEC are described. The video and audio data is divided into data in a period of T0 to T1, a period of T1 to T2, and a period of T2 to the next time according to the timeline of the movement data, and stored in the item “CONTENT BODY”. This facilitates time search and the like of the content. In addition, based on the position (current position) of the device at T2, the position data of T0 and T1 are recalculated and rewritten as −(P1+P2) and −P2, respectively.

In FIG. 10B, 3D image data, space shape surface data, and 3D AR object data will be described.

The 3D image data is video and audio data, and the types of CONTAINER and CODEC are described. In addition, the image is a stereo image, which is configured to include Visual (L) data of the left line of sight and Visual (R) data of the right line of sight, and the two pieces of data are interleaved to be stored in “CONTENT BODY” along the timeline of the line-of-sight movement data. In addition, as in the case of wide-angle image data, position data is rewritten.

The space shape surface data is a collection of surface data (triangular polygon data) having depth data measured by the 3D camera, and is stored in “TIME LINE OF CONTENT BODY” along the timeline of the line-of-sight movement data. Identifiers for distinguishing polygons, such as POLI, POL2, . . . , are given to the polygons. For the depth data a* of the vertex to be measured, data is recalculated in consideration of the movement of the spatial position coordinates, and is stored as the data of each vertex, such as −(a1+P1 +P2).

The 3D AR object data is 3D data of AR objects used for the 3D AR content. “Object Name” and “Copyright Policy” are given to the AR object, and “setting parameters” shown in FIG. 8, which are set in the 3D AR content, are described.

In “CONTENT BODY”, when describing the 3D data of an AR object or when using an AR object of a third party, a URL that can be obtained may be described in the 3D data of the AR object.

In FIG. 10C, 2D image data, 2D AR object data, and 2D composite image data will be described.

The 2D image data is data obtained by performing 2D conversion processing on the 3D image data, and has a similar data structure to the 3D image data except that the 2D-converted image data is described in “TIME LINE OF CONTENT BODY”.

The 2D AR object data is data obtained by performing 2D conversion processing on the 3D AR object, and has a similar data structure to the 3D AR object except that the 2D-converted data is described in “CONTENT BODY”.

The 2D composite image data is image data in which a wide-angle image or a 2D image is combined with a 2D AR object, and has a similar data structure to the 3D image data except that the 2D composite image data is described in “TIME LINE OF CONTENT BODY”.

In addition, the data structures described in FIGS. 10A, 10B, and 10C are examples, and may have other items or may not include some items that are not directly involved in the operation of the present invention.

FIG. 11 is a process flow diagram of the 3D AR content creation device according to the present embodiment. In FIG. 11, the operation mode is determined in S101. If the operation mode is a creation mode, camera setting is performed in S102. The other operation mode is a reproduction and distribution mode, which will be described later.

The camera setting in S102 corresponds to the wide-angle camera and the 3D camera. After the camera setting, the camera image is recorded in S104, and S118 to S121 executed in parallel are the spatial information processing process and the motion information processing process.

After S104, display setting is performed in S105, and the display method of the wide-angle camera image or the display setting of the image of the 3D camera is performed. Then, in S106, the background image display is started. Then, it is determined whether or not the 3D AR content creation process is to be distributed live (S107). If the 3D AR content creation process is to be distributed, the distribution is started (S108). If the 3D AR content creation process is not to be distributed, the distribution is skipped.

Processing from S109 is processing relevant to the 3D AR object. In S109, a 3D AR object to be arranged in the 3D AR content is selected. As for the selection of a 3D AR object, a 3D AR object is selected by reading a 3D AR object that is created in advance or downloaded from an external site and stored in the ROM area or the like of the 3D AR content creation device. The 3D AR object is displayed in S110, the parameters of the 3D AR object are set, and the spatial position coordinates for the arrangement of the 3D AR object are calculated and confirmed (S111). Even after the confirmation is made once, it is possible to operate the 3D AR object by parameter re-setting or the like (S112). This is effective for animation in which moving the 3D AR object is a part of the story of the 3D AR content. A series of operations or 3D AR objects are recorded in S113 and S114. This is to enable reproduction by the 3D AR content playback device. In addition, assuming that the 3D AR content playback device is compatible only with a 2D display, the 3D AR object is converted into 2D (S115), and the 2D object is also recorded (S116). The processing after the selection of the 3D AR object is repeated as long as there is a desired 3D AR object (Y in S125).

In the spatial information processing process of S118 and S119, the surface data of the space shape is extracted from the 3D image, and the spatial position coordinates of the vertices of the surface data are calculated. The surface data and the like are recorded as space shape surface information (S119).

S120 and S121 are a motion information processing process. The movement of the 3D AR content creation device 1 is captured by a gyro sensor, a geomagnetic sensor, and the like. In the motion information processing, necessary spatial position coordinates are updated (S120). The motion information and the updated spatial position coordinates are recorded as motion information and the like (S121).

If the reproduction and distribution mode is determined in S101, the 3D AR content is reproduced (S122), and the reproduced content is distributed (S123). The reproduction and distribution are ended by the end of the content or the end command (S124).

When the creation or the reproduction and distribution of a series of 3D AR content end (N in S125), the process ends in S126.

As described above, according to the 3D AR content creation device of the present embodiment, even if the 3D AR content creation device 1 moves, since the image of the 3D camera and the spatial position coordinates of the 3D AR object are given in the position coordinate space associated with the image of the wide-angle camera after movement, it becomes easy to combine the image of the wide-angle camera with the image of the 3D camera and the 3D AR object. In addition, it is possible to handle a 3D AR object that is outside the range of the image captured by the 3D camera. Therefore, even if the line of sight moves, it is possible to smoothly perform the combined display of the 3D AR object on the wide-angle image and the 3D image. In addition, since 3D combination considering the front-back relationship between the 3D image and the 3D AR object in the depth direction is performed using the depth information of the 3D image, it is possible to create the 3D AR content.

### Second Embodiment

FIG. 12 is a schematic diagram of the appearance of a 3D AR content creation device according to the present embodiment. In FIG. 12, the same components as in FIG. 1 are denoted by the same reference numerals, and the description thereof will be omitted. FIG. 12 is different from FIG. 1 in that a 3D AR content creation device 1a (hereinafter, also referred to as a device 1a) includes a wide-angle camera 10c, a 3D projector 19, and a transmissive screen 20 and the 3D projector 19 and the transmissive screen 20 combine a background image and a 3D AR object.

The wide-angle camera 10c includes lens openings provided at the front and back of its housing, and captures front and back images of the device 1a through the lenses attached to the respective openings. The wide-angle camera 10c has a combined function of the wide-angle cameras 10a and 10b in FIG. 1, and can also be applied to the device 1 in FIG. 1.

FIG. 13 is a block diagram of the configuration of the device 1a according to the present embodiment. In FIG. 13, as compared with FIG. 2, the combination processing unit 152 and the display 12 are replaced with the 3D projector 19 and the transmissive screen 20.

The 3D projector 19 projects a 3D AR object onto the transmissive screen 20. The creator of the 3D AR content checks the projected 3D AR object while viewing the background image through the transmissive screen 20. In this manner, an image in which the background image and the 3D AR object are combined is checked.

In addition, also in the device 1a, the image of the wide-angle camera 10c and the images of the 3D cameras 11a and 11b are recorded in the wide-angle image holding unit 156a and the 3D image holding unit 156b, respectively. As its process follow, the process flow shown in FIG. 11 is applied except for the combination processing unit 152.

FIG. 14 is a display example of the 3D AR content creation device according to the present embodiment, and is an example in which 3D AR objects 4a and 4b are projected onto the transmissive screen 20. A background image can be seen through the transmissive screen 20, and the 3D AR objects 4a and 4b are combined on the background image to form an image.

As described above, according to the present embodiment, the creator of the 3D AR content can check the actual background image viewed from the transmissive screen, and thus there is an advantage that even an untrained creator can safely create the content.

### Third Embodiment

FIG. 15 is a configuration diagram of a 3D AR content creation system according to the present embodiment. In FIG. 15, 1b and 1c are 3D AR content creation devices, 21 is a network 1, 22 is a network 2, 23 is a playback device with a 3D display, and 24 is a playback device with a 2D display. Each of the 3D AR content creation devices 1b and 1c is either the 3D AR content creation device 1 in FIG. 1 or the 3D AR content creation device 1a in FIG. 12.

The 3D AR content creation device 1c also functions as a 3D AR content playback device. In this case, the playback device with a 3D display 23, the playback device with a 2D display 24, and the 3D AR content creation device 1c (may be collectively referred to as a playback device) access the 3D AR content creation device 1b through the network 21 to make a request for reproduction of the 3D AR content. In response to the request, the 3D AR content creation device 1b distributes the 3D AR content. The 3D AR content to be distributed may be different for each of the playback devices 23, 24, and 1c. The playback devices 23, 24, and 1c reproduce the received 3D AR content and display the 3D AR content on the display in the device.

The 3D AR content creation device 1c also functions as a 3D AR content creation device. In this case, the 3D AR content creation device 1c assists the content creation of the 3D AR content creation device 1b. The 3D AR content creation device 1c captures the 3D AR content creation device 1b with a 3D camera, measures the distance and the direction, and transmits the results to the 3D AR content creation device 1b through the network 22. The network 21 and the network 22 are, for example, the Internet and may be the same network, but the network 22 may be configured by Bluetooth (registered trademark). It is often preferable from the viewpoint of responsiveness in the outdoor environment to perform direct communication between the 3D AR content creation device 1b and the 3D AR content creation device 1c.

An example of creating the 3D AR content using the two 3D AR content creation devices 1b and 1c will be described with reference to FIG. 4. The 3D AR content creation device 1b (main content creator) corresponds to the 3D AR object 4b, and the 3D AR content creation device 1c (sub-content creator) corresponds to the 3D AR object 4a. The 3D AR content creation device 1b performs conversion into spatial position coordinates with the 3D AR content creation device 1b as a reference, from the distance and direction information transmitted from the 3D AR content creation device 1c, and displays the 3D AR object 4a.

The 3D AR content creation device 1c (sub-content creator) can create its own image or the like as the sub-content for the content created by the 3D AR content creation device 1b (main content creator). In this case, it is possible to integrate the main content and the sub-content by editing offline to finish the content as one content. However, in real time, the 3D AR content creation device 1b (main content creator) distributes the main content, and the 3D AR content creation device 1c (sub-content creator) distributes the sub-content.

As described above, according to the 3D AR content creation system of the present embodiment, there may be a plurality of content viewers. In addition, different forms of content playback devices may be used.

In addition, it is possible for a plurality of people to create one content. By making a plurality of 3D AR objects appear, it is possible to create the 3D AR content that further arouses the viewer's interest by introducing different points of interest.

### Fourth Embodiment

FIG. 16 is a configuration diagram of a 3D AR content creation system according to the present embodiment. In FIG. 16, components having the same functions as those of the 3D AR content creation system shown in FIG. 15 are denoted by the same reference numerals, and the description thereof will be omitted. FIG. 16 is different from FIG. 15 in that there are a 3D AR content storage service 25 and a 3D AR object bank service 26.

The 3D AR object bank service 26 stores many frequently used 3D AR objects and provides these to 3D AR content creators to save the time and effort of generating 3D AR objects.

The 3D AR content storage service 25 stores the 3D AR content created by the 3D AR content creator and distributes the 3D AR content in response to the request from the content viewer. The 3D AR content creation device only needs to upload the created content to the 3D AR content storage service 25, so that it is possible to separate the load of distributing the content in response to the request from the content viewer.

In addition, the 3D AR content storage service 25 can hold a plurality of 3D AR contents uploaded by a plurality of content creators and distribute a plurality of different 3D AR contents in response to a request from a reproduction viewer.

In addition, by storing the 3D AR content after combining the 3D content and the 3D AR object in the 3D AR content storage service 25, it is possible to enjoy the 3D AR content even on a 3D display device that does not have a combination function. Similarly, by storing the content after combination as a 2D image, it is possible to enjoy the 3D AR composite content in a pseudo manner even on a 2D display device that cannot perform 3D display since the 3D AD content cannot be combined. A monitor of a television or a personal computer, a monitor of a smartphone, and the like may correspond to the 3D display device and the 2D display device.

As described above, according to the present embodiment, the efficiency of content creation can be improved, and the processing load of the 3D AR content creation device can be reduced.

### Fifth Embodiment

FIG. 17 is a block diagram of the configuration of a 3D AR content playback device according to the present embodiment. In FIG. 17, 23 is a 3D AR content playback device, 231 is a camera, 232 is a speaker, 233 is a combination processing unit, 234a is a flat display, 234b is a polarization optical lens, 235 is a mask processing unit, 236 is a communication unit, 237a is a CPU, 237b is a RAM, 237c is a ROM, 238 is a content storage unit, and 239 is a touch sensor.

The 3D AR content playback device 23 in FIG. 17 is the playback device with a 3D display 23 in FIGS. 15 and 16 described above, but alternately displays an image for the left eye and an image for the right eye on the flat display 234a. The polarization optical lens 234b alternately blocks transmission of the right and left lenses in synchronization with the display of left and right images, so that the image for the left eye is viewed by the left eye and the image for the right eye is viewed by the right eye to allow the viewer to view the 3D image. When there is no polarization optical lens 234b, a 2D image is displayed on the flat display 234a, so that the playback device with a 2D display 24 functions. In a configuration in which components other than the polarization optical lens 234b are configured as one piece of hardware and the viewer wears the polarization optical lens 234b as another piece of hardware, such as glasses, the playback device with a 3D display 23 functions when the polarization optical lens 234b is used, and the playback device with a 2D display 24 functions when the polarization optical lens 234b is not used.

Regarding the display capability (whether 3D display is possible or 2D display is possible) of the 3D AR content playback device, when starting the reproduction of the 3D AR content, the 3D AR content creation device or the like is notified of the capability. According to the capability of the 3D AR content playback device, the 3D AR content creation device or the like distributes the 3D image data or the like to a device capable of performing 3D display and distributes the 2D image data or the like to a device having only the 2D display capability, so that it is possible to view the content according to the display capability of the 3D AR content playback device.

The CPU 237a controls the entire system of the device, and its program is stored in the ROM 237c, loaded to the RAM 237b, and executed. The CPU 237a instructs the communication unit 236 to receive the 3D AR content.

The received 3D AR content is reproduced while being buffered in the content storage unit 238. The components of the 3D AR content are wide-angle images, 3D images, space shape surface data, 3D AR objects, and sound. The sound is reproduced by the speaker 232.

The wide-angle images, the 3D images, and the 3D AR objects obtained by reproduction are evaluated by the depth relationship of the spatial position coordinates associated with these, combined by the combination processing unit 233, and displayed on the flat display 234a. The display on the flat display 234a and the polarization optical lens 234b are synchronized, so that a 3D display image is obtained. In the case of the playback device with a 2D display 24 that does not use the polarization optical lens 234b, the image data of the 3D AR content to be received is designated as 2D and received. Even in this case, the depth relationship of the spatial position coordinates is evaluated, combination is performed by the combination processing unit 233, and the result is displayed on the flat display 234a.

The touch sensor 239 receives an input operation of the viewer. This is used to select a displayed 3D AR object, set parameters from a menu object, or move the line of sight by designating a point of a wide-angle image or a 3D image.

In addition, the processing of each processing unit in FIG. 17 may be performed by software processing in which the CPU executes a program stored in the memory, or may be performed by hardware processing using a dedicated signal processing circuit. In addition, software processing and hardware processing may be performed in combination.

FIG. 18 is a process flow diagram of the 3D AR content playback device according to the present embodiment. In FIG. 18, the 3D AR content creation device 1 or 1a logs in to the 3D AR content storage service 25 in S201, and downloads a thumbnail image (S202). The thumbnail image may be a still image or a moving image. However, the thumbnail image is displayed in S203 to facilitate intuitive selection of the content to be reproduced from a plurality of 3D AR contents.

In S204, it is determined whether the display is performed in 2D or 3D. If the display is performed in 3D, processing from S205 is performed. If the display is performed in 2D, the process proceeds to S214.

In the process flow of 3D display, downloading of the 3D AR object is started in S205, and downloading of the 3D image data and the wide-angle image is started in S206. Then, display setting is performed in S207, display is started or updated in S208, so that the 3D AR content is viewed.

During the viewing period of the 3D AR content, it is possible to operate the 3D AR object to adjust the content to the viewer's preference. Therefore, the setting of the object is changed in S209. In addition, in S210, it is also possible to display the viewer's original image in the masked area. In addition, in S211, it is possible to give an instruction for discontinuous movement (interactive reproduction) of the viewpoint of the viewer.

In S212, the presence or absence of a user operation is determined. If there is a user operation, the display is updated in S208. If there is no user operation, it is determined whether or not to continue to view the content (S213). If this is to be continued, the process returns to S205 to continue to view the content.

When ending the viewing of the content, the process ends in S223. From S223, the process may return to S203 in order to view new content.

In the process flow of 2D display, downloading of the 2D AR object converted into 2D is started in S214, and downloading of the wide-angle image and the image data converted into 2D is started in S215. The processing of S216 to S222 and S223 is the same as the flow of 3D display.

Next, a 3D AR content display example of the 3D AR content playback device 23 will be described with reference to FIGS. 19 to 22.

FIG. 19 is an example of a display setting object 27 for performing a display setting in the present embodiment. Display/non-display of a wide-angle image, display/non-display of a 3D image, the display size of a 3D image when the 3D image is combined with the wide-angle image, and display/non-display of a viewer's original image in a mask area are set. The viewer's original image may be an image of a camera 231 built into the 3D AR content playback device 23. In addition to this, display/non-display of space shape surface data may be set.

FIG. 20 is an example in which a 3D image is displayed on the entire surface of the flat display 234a. In this example, the space shape surface data 6 is also displayed, and the viewer's original image 28 is combined and displayed in the masking surface area 8a.

FIG. 21 is a display example of 360° 3D AR content similar to FIG. 3 described above, and is an example in which the image 2 of the wide-angle camera, the image 3 of the 3D camera, and the 3D AR objects 4a, 4b, 4c, 4d, 4e, and 4f are combined and displayed.

In addition, in FIG. 21, operation objects 28a, 28b, 28c, 28d, and 28e are displayed. The operation object 28a is movable, and the viewer can select an arbitrary 3D AR object, change parameters in the object setting of FIG. 8, or perform an operation of moving the viewpoint to the selected 3D AR object. Reference numerals 28b, 28c, 28d, and 28e are scroll objects, which enable scroll movement of the wide-angle image 2. Even though scroll objects, such as the scroll objects 28b, 28c, 28d, and 28e, can be displayed to prompt an operation, the operation can also be assigned to a pattern of finger movement on the touch sensor 239. When the wide-angle image 2 is scrolled, the 3D image 3, the 3D AR objects 4a, 4b, 4c, 4d, 4e, and 4f, and the operation object 28a are also interlocked.

In addition, the display examples of FIGS. 3, 4, and 5 in the description of the 3D AR content creation device of the first embodiment can also be display examples of the 3D AR content playback device.

FIG. 22 is a diagram showing the process flow of the combination processing unit 233 of the 3D AR content playback device 23 in FIG. 17. In FIG. 22, a 3D AR object to be combined is selected in S301, and it is checked in S302 whether or not the display priority of the 3D AR object is set by the parameter of the object shown in FIG. 8. If the display priority is set, the 3D AR object is displayed on the front surface in S305.

When the display priority is a normal mode, the surface data of the space shape overlapping the 3D AR object is determined (S303), and the depth relationship between the 3D AR object and the surface data is evaluated (S304). The evaluation result is held (S305). In S306, according to the evaluation result, the image of the 3D camera is displayed in front of the image of the 3D AR object when the surface data of the space shape is on the front, and the image of the 3D AR object is displayed on the front surface when the 3D AR object is on the front. At this time, the above is based on the transparency in FIG. 8. For example, when the transparency is medium, the image of the 3D camera and the image of the 3D AR object are combined by alpha blending in which two images are combined by a coefficient.

Then, in S307, it is determined whether or not there is another 3D AR object to be combined. If there is another 3D AR object, the process returns to S301, and if not, the process ends.

As described above, according to the present embodiment, it is possible to reproduce and display the 3D AR content regardless of whether the display device is a 3D device or a 2D device. In addition, the 3D AR object or the mask area of the 3D AR content can be operated to perform reproduction in a viewer's original method. In addition, by moving the line of sight, it is also possible to interactively reproduce the 3D AR content.

While the embodiments have been described above, the present invention is not limited to the embodiments described above, and includes various modification examples. For example, the above embodiments have been described in detail for easy understanding of the present invention, but the present invention is not necessarily limited to having all the components described above. In addition, it is possible to add the configuration of another embodiment to the configuration of one embodiment. In addition, for some of the components in each embodiment, addition, removal, and replacement of other components are possible.

### REFERENCE SIGNS LIST

1, 1a, 1b, 1c 3D AR content creation device
2 Image of wide-angle camera
3 Image of 3D camera
4a, 4b, 4c, 4d, 4e, 4f 3D AR object
5a, 5b Menu object
6 Space shape surface data
7 Parameter setting object
8a Surface area to be masked
8b Mask setting object
10a, 10b, 10c Wide-angle camera
11a, l1b 3D camera
12, 12a, 12b Display
13 Polarization optical lens
15 Controller
17 Sensor
18 User operation input unit
19 3D projector
20 Transmissive screen
21, 22 Network
23 Playback device with 3D display
24 Playback device with 2D display
26 3D AR object bank service
25 3D AR content storage service
27 Display setting object
28 Viewer's original image
28a, 28b, 28c, 28d, 28e Operation object
151a Space shape surface processing unit
151b Depth information processing unit
151c Brightness information processing unit
151d Color Information processing unit
152 Combination processing unit
153 Mask processing unit
154a CPU
154b RAM
154c ROM
154d Communication unit
155 Spatial position coordinate processing unit
156a Wide-angle image holding unit
156b 3D image holding unit
156c Space shape surface data holding unit
156d 3D AR object holding unit
156e 2D image holding unit
156f 2D AR object holding unit
156g Line-of-sight movement data holding unit
157 2D conversion processing unit
158 2D-converted image and thumbnail data holding unit
159 User operation data holding unit
231 Camera
232 Speaker
233 Combination processing unit
234a Flat display
234b Polarization optical lens
235 Mask processing unit
238 Content storage unit
239 Touch sensor

1. A 3D AR content creation device, comprising:
a camera;
a position information sensor that detects position information of the camera; and
a controller,
wherein the controller measures depths of feature points of at least a part of a background image captured by the camera, gives position coordinates of a space corresponding to the background image to an AR object having the feature points of the background image and a 3D image from the position information of the camera and the measured depths of the feature points, and evaluates depths of the feature points of the background image and the AR object to obtain a composite image.

2. The 3D AR content creation device according to claim 1,
wherein the camera is a 3D camera that captures a 3D image as a background image, and
the controller generates space shape surface data as a collection of surface data having the feature points of the background image as vertices.

3. The 3D AR content creation device according to claim 1, further comprising:
a wide-angle camera that has a wider imaging area than a camera for capturing a background image and obtains a wide-angle image,
wherein the controller gives position coordinates of a space corresponding to the wide-angle image to the feature points of the background image, and arranges an AR object having a 3D image in a space corresponding to the wide-angle image.

4. The 3D AR content creation device according to claim 3,
wherein the wide-angle camera that obtains the wide-angle image is a 360° camera that captures approximately 360° surrounding images.

5. The 3D AR content creation device according to claim 1, further comprising:
a 3D display that performs 3D display of the composite image.

6. The 3D AR content creation device according to claim 3,
wherein the controller stores the background image or the background image and the wide-angle image.

7. The 3D AR content creation device according to claim 1,
wherein the controller measures movement of the camera or the wide-angle camera, recalculates position coordinates of a space given to the AR object having the feature points of the background image and the 3D image based on measured movement data, and stores the measured movement data.

8. The 3D AR content creation device according to claim 7,
wherein the controller gives a parameter to the AR object having the 3D image, and has a parameter for selecting a method of subtracting the movement data from the position coordinates of the space and a method of holding the position coordinates of the space as a method of recalculating the position coordinates of the space with respect to movement of the camera or the wide-angle camera.

9. The 3D AR content creation device according to claim 2,
wherein the controller designates one or more pieces of surface data having feature points of the image as vertices and masks a background image of an area of the designated surface data.

10. The 3D AR content creation device according to claim 1,
wherein the controller converts the background image and the 3D image of the AR object into 2D images and stores the converted background image and the converted image of the AR object.

11. The 3D AR content creation device according to claim 10,
wherein the controller evaluates the depths of the feature points of the background image and the AR object, and obtains a composite image of a 2D-converted background image and a 2D-converted AR object, and stores the composite image.

12. A 3D AR content playback device, comprising:
a playback device; and
a display,
wherein the playback device reproduces a background image having position coordinates at feature points, reproduces an AR object having position coordinates of a space to which the feature points of the background image belong, compares the position coordinates of the feature points of the background image with the position coordinates of the AR object, obtains a composite image of the background image and the AR object based on the comparison result, and displays the composite image on the display.

13. The 3D AR content playback device according to claim 12,
wherein the playback device reproduces a wide-angle image having a wider image area than the background image, compares the position coordinates of the feature points of the background image and the position coordinates of the AR object, which are position coordinates in a space corresponding to the wide-angle image, obtains a composite image by arranging the background image and the AR object on the wide-angle image based on the comparison result, and displays the composite image on the display.

14. The 3D AR content playback device according to claim 12,
wherein the background image, the AR object, and the composite image are 3D images, and
the playback device performs 3D display on the display.

15. The 3D AR content playback device according to claim 12,
wherein the playback device has a touch sensor for a viewer to operate a 3D AR content, updates the position coordinates of the feature points of the background image and position coordinates of a 3D AR object by selecting a 3D AR object on the composite image displayed on the display or by designating points of the background image, obtains a composite image that moves the viewer's line of sight to the selected location, and displays the composite image.

16. The 3D AR content playback device according to claim 14,
wherein the playback device gives parameters to an AR object having the 3D image so that one or more of 3D image transparency, display priority, rotation, movement, and size change can be set.

17. The 3D AR content playback device according to claim 12,
wherein the playback device reproduces space shape surface data as a collection of surface data having the feature points of the background image as vertices, generates or reproduces an insertion image, replaces the background image with the insertion image in one or more areas of the surface data to obtain a replacement image, and displays an image including the replacement image.

18. The 3D AR content playback device according to claim 12,
wherein the playback device reproduces a 2D-converted background image and a 2D-converted AR object, compares the position coordinates of the feature points of the background image with the position coordinates of the AR object, obtains a composite image of the 2D-converted background image and the 2D-converted AR object based on the comparison result, and displays the composite image on the display.

19. A 3D AR content creation system having the 3D AR content creation device according to claim 1, comprising:
a 3D AR content playback device and at least two first and second 3D AR content creation devices connected to a first network,
wherein each of the first and second 3D AR content creation devices has a configuration of the 3D AR content creation device,
the first 3D AR content creation device distributes a 3D AR content to the 3D AR content playback device through the first network,
the first and second 3D AR content creation devices are connected by a second network, and
the second 3D AR content creation device transmits a positional relationship with the first 3D AR content creation device to the first 3D AR content creation device through the second network.

20. A 3D AR content creation system having the 3D AR content playback device according to claim 12, comprising:
a 3D AR content creation device, the 3D AR content playback device, a 3D AR object bank service, and a 3D AR content storage service that are connected to a first network,
wherein the 3D AR content creation device downloads a 3D AR object from the 3D AR object bank service through the first network, and uploads the created 3D AR content to the 3D AR content storage service through the first network, and
the 3D AR content playback device downloads a 3D AR content from the 3D AR content storage service through the first network.
